(19) United States
(12) Patent Application Publication
(10) Pub. No.: US 2006/0156654 A1
(43) Pub. Date: Jul. 20, 2006

(54) Clad window frame with improved sealing

(75) Inventor: David J. Weiss, Stillwater, MN (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Andersen Corporation, Bayport, MN (US)

(21) Appl. No.: 11/039,099

(22) Filed: Jan. 20, 2005

(51) Int. Cl. E06B 3/00

(52) U.S. Cl. 52/204.5

(57) ABSTRACT

A leak resistant clad window has a sill, spaced vertical jambs, and a header. A barrier pan is installed over and clads the sill of the window and includes upwardly extending end walls that extend partially up the vertical jambs. Jamb liners are installed on the inside faces of the jambs and the bottom portions of the jamb liners overlie the upwardly extending end walls of the barrier pan. An inside edge wall projects upwardly along an inside edge of the barrier pan and extends between the end walls. The barrier pan preferably is made of a unitary piece of molded plastic. Water that may seep into joints, particularly at the bottom corners of the window, are captured in the barrier pan and directed outwardly to be shed away from the window.

### TECHNICAL FIELD

This Invention relates generally to fenestration and more particularly to prevention or reduction of leaks at the bottom corners of a clad window frame.

### BACKGROUND

Fenestration units such as window frames often are waterproofed and protected from weathering by cladding them with formed sheets of material resistant to weathering and water penetration. Typical cladding materials include, for example, plastics, such as polyvinyl chloride (PVC), and aluminum. Cladding components may be produced by molding, extruding, bending, or otherwise forming the cladding material into pieces having shapes that conform to the profiles of at least the exterior portions of underlying window frame elements, such as jambs, sills, and headers, which often are made of wood. The formed cladding is then fitted and attached to the wooden elements of the frame to cover the wood and protect it from moisture and attendant rot and decay. Cladding components typically are held in place on their underlying wooden frame elements by adhesives or mechanical fastening mechanisms. It often is useful to incorporate snap-fitting tongues or other self attaching devices into cladding components that mate with corresponding slots milled in frame elements to simplify assembly and avoid leaks that otherwise might result from holes required for screws, rivets, and similar fasteners.

Because window cladding is formed in separate pieces that are attached to the corresponding elements of a window frame, such as the jambs and sill, joints between cladding components result where the separate pieces of cladding meet. One such joint that historically has been particularly troublesome is the joint between the cladding that covers a window sill and the jamb liners that cover the inside faces of the window jambs. These joints occur at the bottom corners of the window frame and, unless properly sealed, can result in water leakage to underlying wooden window frame elements. In order to seal cladding joints, sealants such as silicone RTV historically has been used. While such sealants can produce adequate sealing, particularly in the short term, it has been found that considerable skill and patience may be required during application to avoid sealing defects, a limitation that may be incompatible with manufacturing requirements because of the likelihood of immediate or eventual leaks. Even where sealing is applied precisely according to requirements, the sealed joints can, over time, develop leaks due to a number of factors including, for instance, thermal expansion and contraction of cladding components, movement and settlement, and physical damage.

FIGS. 1 and 2 show, in highly simplified form, a common prior art clad window illustrating the problems described above. A window frame 10 includes a sill 12 having a top surface 11. Spaced vertical jambs 14 and 16, partially illustrated, are attached to the ends of the sill. Some or all of the exterior surfaces of these components may be covered by a cladding material, such as extruded PVC. For simplicity, the windows shown in FIGS. 1 and 2 show the sill 12 being covered by a plastic sill cladding 13 and the inside facing surfaces of the jambs 14 and 16 being covered by plastic jamb liners 15. It will be understood that other cladding components may cover other portions of the frame. For example, the window unit may include cladding covering outside edges of the frame and/or the brick mold attached around the outside edges. In FIG. 2, sill cladding 13 and a pair of jamb liners 15 and 17 are shown assembled onto window frame 10, with these cladding components meeting at joints 6 and 7. The jambs and jamb liner are configured for slidably receiving one or more window sashes 21 in the traditional way. As described above, an exterior sealant such as silicone RTV traditionally is applied along joints 6 and 7 to prevent leakage at these locations. However, leaks often can develop along these joints anyway, resulting in rotting and deterioration of the underlying wooden window frame elements.

Accordingly, a need exists for a solution that eliminates or at least greatly reduces instances of leaks at joints between cladding components in clad windows, and particularly at the bottom corners of a window unit. Such a solution should be installable during window assembly-with a minimum of required skill level yet still provide superior and virtually fool-proof sealing against water penetration. Further, the sealing characteristics should be permanent and should not degrade over time due to thermal or mechanical influences. It is to the provision of such a solution that the present invention is primarily directed.

### SUMMARY OF THE INVENTION

Briefly described, the present invention, in one preferred embodiment thereof, comprises an improved and enhanced cladding system for clad windows that substantially eliminates leaks at the bottom corners of windows and also eliminates or at least reduces the criticality of traditional sealants applied in these locations. The invention includes a sill cladding that is shaped to define a barrier pan having upwardly extending end walls configured to project upwardly a short distance beneath the vertical jamb liners of the window. An upturned or upwardly extending interior edge wall extends along the inside edge of the barrier pan between the upwardly extending end walls. The barrier pan with its upwardly extending end and edge walls thus forms a sill cladding that captures any moisture that may leak through the joint between the sill cladding and jamb liners and prevents the moisture from penetrating through to underlying wooden elements of the window frame. While sealant still can, and likely should, be used at critical cladding joints, the criticality of this sealant and its application is greatly reduced because the consequences of leakage are virtually eliminated by the unique barrier pan of the present invention.

According to a preferred embodiment, the barrier pan is formed of thermoplastic polymeric material such as PVC by traditionally known fabrication methods such as injection molding or thermoforming. Other materials, such as aluminum, also can be used. Further, the barrier pan can be formed of multiple assembled components such as, for instance, a pan portion to provide the barrier function and a cover portion to provide suitable appearance and weatherability. During window unit assembly, the barrier pan cladding is installed covering the sill of a window with its end walls extending partially up the vertical side jambs. Jamb liners are then installed, with the bottoms of the jamb liners overlapping the end walls of the barrier pan. Other cladding components also may be attached to the frame. Assembly may include the application of a sealant at the junction of the jamb liners and barrier pan to reduce the likelihood of leakage; however, such a sealant may not be required at all because any leakage that occurs is captured by the upwardly extending end walls and inside edge wall of the barrier pan and directed outward to the edge of the sill, where it can drain away from the window in the usual way.

Thus, a window cladding system is now provided that virtually eliminates leakage at the bottom corners of the window where leakage has traditionally been a primary concern. At the same time, the cladding system is simple and efficient to install during window unit assembly, does not involve the elevated skill level required in the past for sealant application, and is not likely to develop leaks over time. These and other objects, features, and advantages of the window cladding system of this invention will become more apparent upon review of the detailed description set forth below, when taken in conjunction with the accompanying drawing figures, which are briefly described as follows.

### BRIEF DESCRIPTION OF THE DRAWINGS

FIG. 1 is a perspective partially exploded view illustrating, in simplified form, a traditional prior art window cladding system, which is discussed above.

FIG. 2 is a perspective view of the prior art window cladding system of FIG. 1 assembled onto a window frame and illustrating joints where sealant traditionally is applied.

FIG. 3 is a perspective view of a sill cladding configured according to the invention to form a barrier pan.

FIG. 4 is a perspective exploded view of a portion of a window unit illustrating installation of a barrier pan and jamb liner in a window according to the invention.

FIG. 5 is a perspective view of the portion of the window unit of FIG. 1 shown in its assembled state.

FIG. 6 is a perspective exploded view of an alternate embodiment of the present invention wherein the barrier pan is overlaid with an ancillary aesthetic cover.

### DETAILED DESCRIPTION OF THE PREFERRED EMBODIMENTS

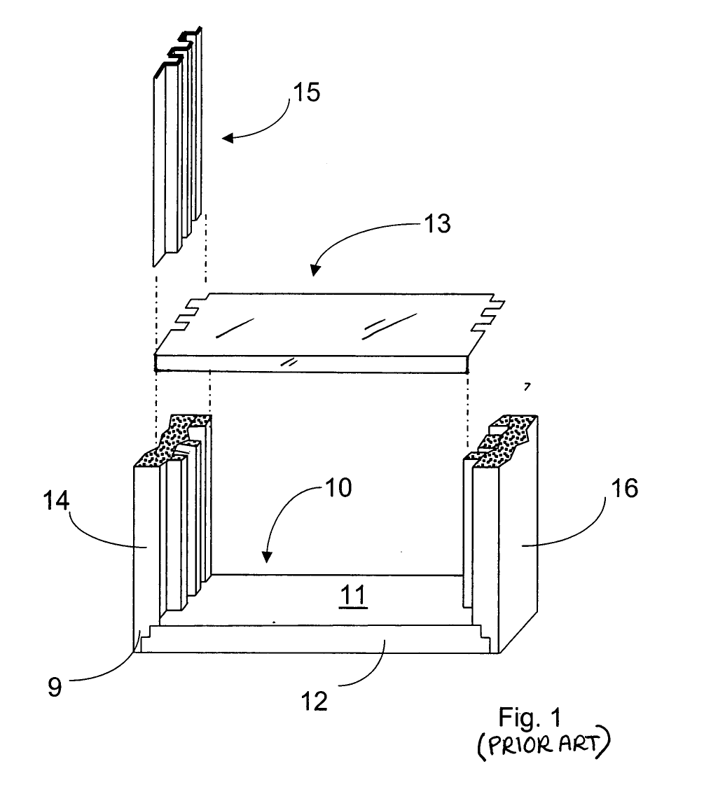

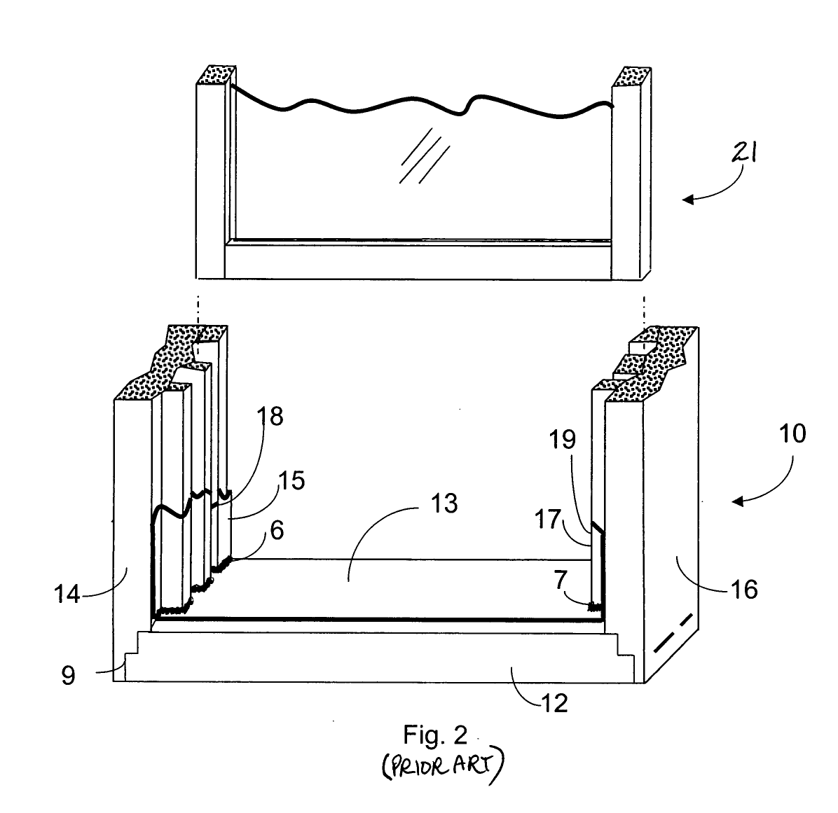

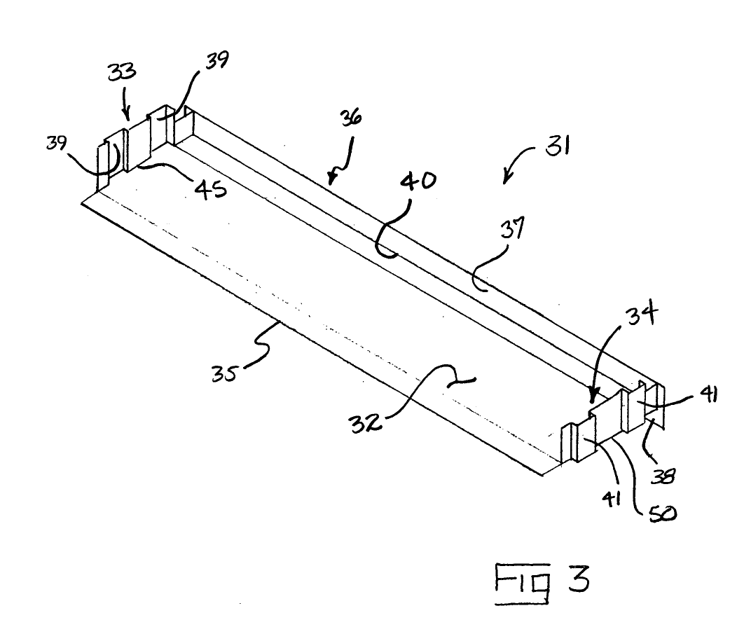

Referring now in more detail to the drawing figures, wherein like reference numerals indicate, where appropriate, like parts throughout the several views, FIGS. 1 and 2 illustrate, in simplified form, a prior art clad window unit, which is discussed in some detail above. FIGS. 3 through 6 illustrate embodiments of the present invention, which will now be discussed in more detail.

FIG. 3 shows an improved window sill cladding in the form of a barrier pan 31 that embodies principles of the present invention in one preferred form. The window barrier pan preferably is molded of a single unitary piece of relatively thin-walled water proof material such as, for instance, PVC plastic. The barrier pan 31 generally is shaped and configured to conform to the profile of the window sill it will cover. More specifically, the barrier pan 31 has a relatively flat floor 32 that is shaped to conform to the profile of the upper surface of a window sill. The floor 32 extends outwardly to an outside edge 35 and inwardly to an inside edge 40, and has opposed end portions 45 and 50 respectively.

A left end wall 33 is an integrally formed part of the barrier pan 31 and extends upwardly from the end portion 45 of the floor 32. In the illustrated embodiment, the upwardly extending end wall 33 is formed with a pair of recesses configured to fit within corresponding recesses 39 along the vertical jamb of a window frame when the barrier pan 31 is installed on the window sill, as detailed below. Similarly, an upwardly extending right end wall 34 is an integrally formed part of the barrier pan 31 and extends upwardly from the opposite end portion 50 of the floor 32. The upwardly extending end wall 34 likewise is formed with a pair of recesses 41 shaped to fit within corresponding recesses along the opposite vertical jamb of a window frame when the barrier pan 31 is installed on the window sill.

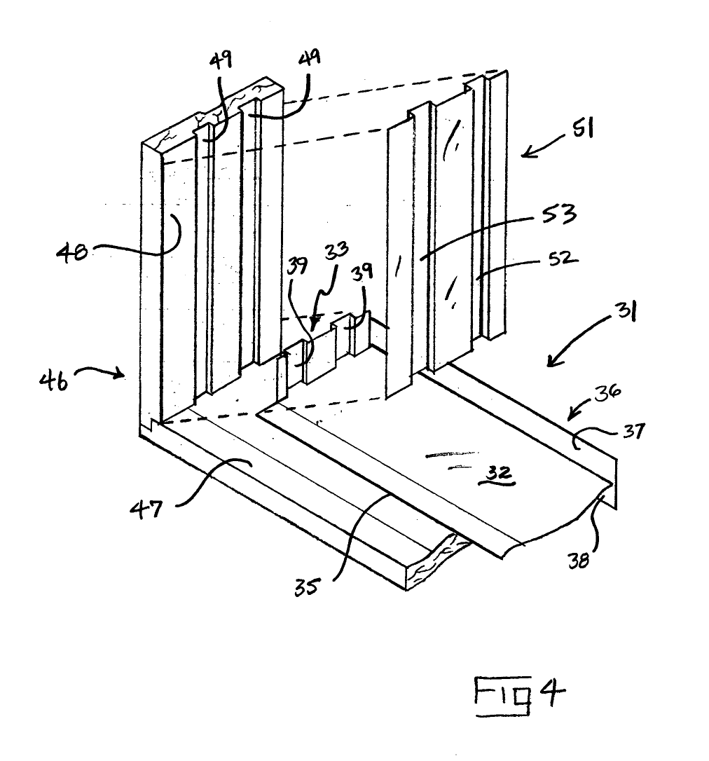

An inside edge wall 36 extends along the inside edge portion 40 of the floor 32 and, like the end walls 33 and 34, preferably is an integrally formed part of the barrier pan 31. The inside edge wall 36 extends between and connects the opposed end walls 33 and 34 and has an upwardly extending portion 37 that projects upwardly from the floor 32. Optionally, a depending portion 38 that projects downwardly from the floor 32 (as perhaps best seen in FIG. 4) can also be provided. Downwardly depending portion 38 is useful in aligning barrier pan 31 relative to the window sill. Since the entire barrier pan 31 preferably is formed of a unitary piece of molded or thermoformed plastic, it will be seen that the floor, end walls, and inside edge wall form a three sided pan that prevents water leakage at the ends and inside edge of the pan and constricts water to flow toward the outside edge 35 of the pan, where it can drain away.

FIG. 4 is an exploded perspective view illustrating assembly of a window unit incorporating the barrier pan of the present invention to prevent leakage at the bottom corners of a window unit. In this figure, as in other figures, the profiles of the window sill, jambs, and jamb liners are highly simplified for ease and clarity of explanation of the invention. In fact, some aspects are grossly oversimplified. For instance, modern jamb liners are complex extrusions that incorporate counterbalancing mechanisms, allow for tilt-in washing of window sashes, and perform other functions. In the embodiments shown herein, however, the jamb liners are illustrated as simple profiles that match the equally simplified profiles of the vertical jambs of the window frame. While such simplification bears little resemblance to real world window units, it nevertheless allows for a clear and uncluttered description of the present invention. It will be understood that the invention disclosed herein is equally applicable to even the most complex cladding components and no limitation should be inferred from the oversimplification of the illustrated embodiments in the drawings, since such is done for clarity of description only.

In FIG. 4 a window frame 46 is shown along with an exploded illustration showing installation of window cladding during window assembly according to the invention. Of course, only a portion of the window frame is shown here, but it will be understood that the complete frame includes a sill, a pair of upwardly extending window jambs forming the sides of the frame, and a head jamb or header forming the top of the frame. In any event, the barrier pan 31 is installed in the window frame covering the sill 47 thereof, as illustrated by phantom lines in FIG. 4. When in place, the floor 32 of the barrier pan overlies and protects the top of the sill 47 while the upwardly extending end walls 33 and 34 extend partially up each of the vertical jambs, the profiles of the end walls preferably matching and conforming to the profiles of their corresponding jambs. At the same time, the upwardly extending portion 37 of the inside wall 36 extends along and projects upwardly from the inside edge portion of the sill 47. Jamb liners 51 are then installed on the inside faces of the jambs 48 with the bottoms of the jamb liners overlapping the upwardly extending end walls of the barrier pan 31, and with the extreme bottom ends of the jamb liners resting on the floor 32 of the barrier pan. At this point in the assembly process, a sealant may be applied to the joint between the jamb liner bottom and the floor of the barrier pan if desired; however, such a step is not absolutely necessary and may be skipped if desired.

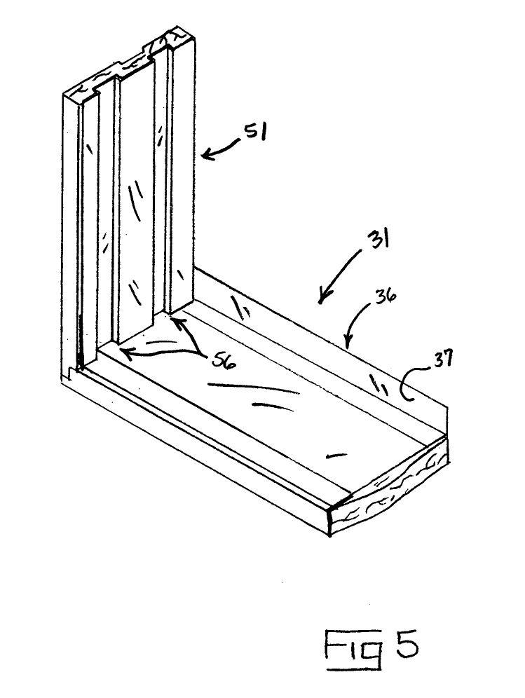

FIG. 5 illustrates an assembled clad window frame incorporating principles of the present invention. The barrier pan 31 is seen installed covering and forming a cladding for the sill of the frame while the jamb liner 51 is seen covering and cladding the inside face of the vertical jamb. As discussed above, the bottom portion of the jamb liner overlaps the upwardly extending end wall of the barrier pan 31. In this way, any water that may leak between the junction of the jamb liner and the barrier pan is captured by the barrier pan and prevented from seeping to wooden jamb components below. The water is instead directed toward the outside edge of the jamb, where it is drained away from the window unit. Thus, the age-old problem of rot and deterioration at the bottom inside corners of windows is eliminated, resulting in a window unit that performs with full integrity for many years.

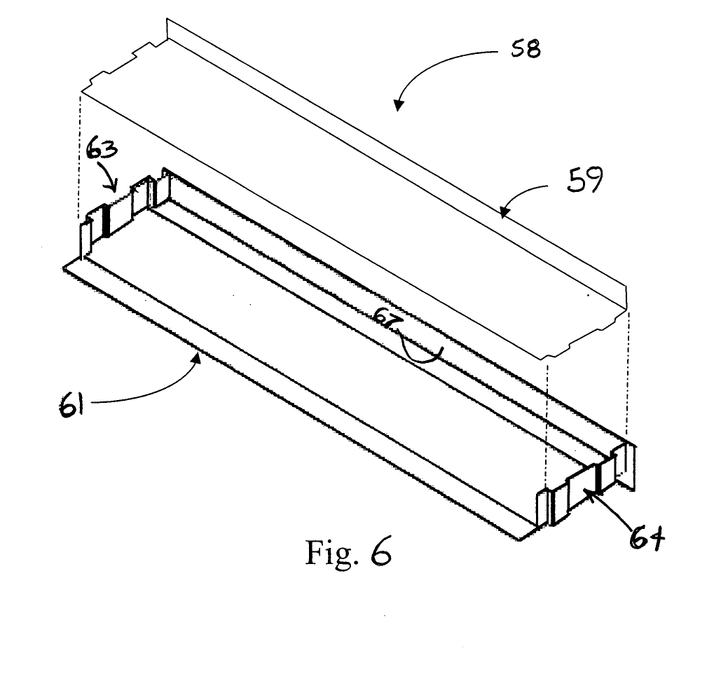

FIG. 6 illustrates an alternate embodiment of a barrier pan of the present invention. Here, like the prior embodiment, the barrier pan 61 is integrally formed with upwardly extending profiled end walls 63 and 64 and an upwardly extending inside edge wall 67. In this embodiment, however, an additional piece of decorative or otherwise aesthetic cladding 58 having inside edge 59 is installed atop the barrier pan 61 and, subsequently, jamb liners and other elements are installed as described above. The embodiment of FIG. 6 provides numerous advantages such as, for instance, the barrier pan 61, since it is covered by the aesthetic cladding 58, need not be made of a high quality more expensive plastic material nor need it be tinted or colored. It can, in fact, be made of recycled plastic material, if desired, in which case it still performs equally well the functions of leak prevention with a less expensive more environmentally friendly product. Even though the aesthetic cladding 58 is made of a more expensive plastic material, it can be extruded as substantially flat pieces that are cut off as needed, which is far less expensive than the molding or thermal forming required for the barrier pan.

As discussed above, the barrier pan of this invention preferably is formed of a unitary piece of molded or thermoformed plastic so that there are no joints that might leak at, for instance, the ends and edges of the pan floor. It is within the scope of the invention, however, that the barrier pan be formed from two or more separate pieces that are joined together in any known watertight manner to prevent leaks. Further, the barrier pan may be referred to as being formed of “thin walled” material, meaning that all wall thicknesses are significantly less than other dimensions of the barrier pan. Subject to this general limitation, wall thickness for the barrier pan are not particularly limited, although very thin materials may not be sufficiently durable and may be too fragile to be handled easily during window assembly while very thick materials may be needlessly heavy, expensive, and difficult to fabricate. Generally, suitable wall thickness depends on the particular material used, fabrication methods, and the severity of service the window is expected to withstand. It has been found, for example, that a suitable wall thickness when using PVC for the barrier pan is between about 0.020 inches and 0.100 inches, and most preferably about 0.060 inches.

The end walls of the barrier pan extend upwardly from the ends of the pan floor a distance that is predetermined to insure that water cannot, under normal weather conditions, seep or be blown over the top of the end walls and onto the wooden window components beneath. More specifically, in order for water to rise over the top of an end wall (or the inside edge wall) the water must be under pressure, measured in inches of water, greater then the height of the end wall, measured in inches. Pressure can be created at the bottom corners of a window in a blowing rainstorm. The height of the end walls is predetermined so that even the maximum expected pressures are less than the height of the end walls to insure no leakage over the end walls.

Specific wall height requirements can be determined by the required water resistance test pressure. Water resistance test pressures for various performance classes are found in published performance standards such as 101/I.S. 2/A440, SPECIFICATIONS FOR WINDOWS, DOORS, AND UNIT SKYLIGHTS, available from the American Architectural Manufacturers Association, and the Window and Door Manufacturers Association, and available online at nwwda.org-files-public-specifications.pdf. These standards list a range of performance classes, along with the required minimum water resistance test pressures for each performance class. Water resistance test pressure is measured according to ASTM E 331-00, for constant pressure, and E 547-00 for cycled pressure. Exemplary performance requirements are shown in Table 1. Wall heights that are at least as great as the minimum water resistance pressure, measured in inches of water, shown in Table 1, satisfy the criteria set forth hereinabove.

TABLE 1

| | | Minimum | Minimum |
|---|---|---|---|
| | Minimum | Water | Water |
| Product | Design | Resistance | Resistance |
| Performance | Pressure | Test Pressure | Test Pressure |
| Class | (psf) | (psf) | (inches of water) |
| R—Residential | 15 | 3.0 | 0.58 |
| LC—Light Commercial | 25 | 3.8 | 0.73 |
| HC—Heavy Commercial | 35 | 5.3 | 1.02 |
| AW—Architectural | 45 | 9.0 | 1.73 |
| Windows | | | |

It will be appreciated that while the end walls and inside edge walls are generally portrayed as being of the same height, as shown for example in FIGS. 3, 4, and 6, this need not be the case, provided all walls are of sufficient height to provide adequate water resistance pressure.

While the end walls of the barrier pan are effective as dams to block water from seeping to underlying window frame components, it may be desirable in some cases also to apply sealants or gasket materials to joints and overlapping surfaces between jamb liners and the barrier pan to reduce further the probability of leaks. Suitable sealants and/or gaskets include compliant tapes, as well as sealants, such as silicone-based sealants, applied as liquids to the surface and cured to a compliant layer. The area of overlap between the end walls and jamb liners in combination with the pressure exerted by the jamb liners on the end walls provides highly favorable conditions for sealing. Sealing of the jamb liners against the end walls is enhanced when the bottom sash of the window is closed since, in this position, the sash presses against the jamb liners to urge them against the end walls.

The invention has been described herein in terms of preferred embodiments and methodologies considered by the inventors to be the best mode of carrying out the invention. It will be understood, however, that various additions, deletions, and modifications might be made to the illustrated embodiments within the scope of the invention. For instance, as previously mentioned, the invention is equally applicable to window units with highly complex jamb liners and other cladding components. While plastic such as vinyl is the preferred material for the barrier pan of this invention, other materials, aluminum for instance, might be selected in appropriate applications. Finally, while the invention has been illustrated in the context of clad windows, other applications of the invention, such as certain doors, also may be possible. These and other modifications, changes, and additions to the preferred embodiments illustrated herein might be made by those of skill in the art without departing from the spirit and scope of the invention as set forth in the claims.

What is claimed is:

1. A clad window comprising:
a window frame having a sill, spaced apart vertical jambs, and a header;
a barrier pan mounted on and at least partially covering and cladding said sill;
said barrier pan having a floor, a first upwardly extending end wall that extends partially up one of said vertical jambs and a second upwardly extending end wall that extends partially up the other one of said vertical jambs;
a first jamb liner mounted to one of said vertical jambs, said first jamb liner having a bottom portion overlapping one of said upwardly extending end walls of said barrier pan; and
a second jamb liner mounted to the other one of said vertical jambs, said second jamb liner having a bottom portion overlapping the other one of said upwardly extending end walls of said barrier pan.

2. A clad window as claimed in claim 1 and wherein said barrier pan is further formed with an upwardly extending inside edge wall extending between said first and second end walls, said end walls and said inside edge wall forming a pan for preventing water leakage to underlying window frame components.

3. A clad window as claimed in claim 1 and wherein said barrier pan is formed of plastic.

4. A clad window as claimed in claim 3 and wherein said barrier pan is formed of recycled plastic.

5. A clad window as claimed in claim 3 and wherein said barrier pan is formed of Polyvinyl Chloride (PVC).

6. A clad window as claimed in claim 3 and wherein said barrier pan is formed of a unitary piece of plastic.

7. A clad window as claimed in claim 6 and wherein said barrier pan is injection molded.

8. A clad window as claimed in claim 6 and wherein said barrier pan is thermally formed.

9. A clad window as claimed in claim 1 and further comprising an aesthetic covering overlying at least a portion of said barrier pan.

10. A clad window as claimed in claim 9 and wherein said aesthetic covering substantially covers said floor of said barrier pan.

11. A barrier pan for at least partially cladding a sill of a window unit having a sill and spaced upwardly extending jambs, said barrier pan having a floor conforming substantially to the profile of said sill and having first and second ends and an inside edge, a first upwardly extending end wall at said first end of said floor, and a second upwardly extending end wall at said second end of said floor, said first and second end walls configured and positioned to extend partially up corresponding ones of said vertical jambs to prevent water leakage at the junctions of said sill and said jambs.

12. A barrier pan as claimed in claim 11 and further comprising an inside edge wall projecting upwardly from said inside edge of said floor and connecting said first and second end walls to form a watertight barrier around three sides of said floor.

13. A barrier pan as claimed in claim 11 and wherein said end walls are coupled to said floor in a watertight manner.

14. A barrier pan as claimed in claim 11 and wherein said barrier pan is molded from a unitary piece of material.

15. A barrier pan as claimed in claim 14 and wherein said barrier pan is molded from plastic.

16. A barrier pan as claimed in claim 15 and wherein said barrier pan is molded from PVC.
